(19) United States
(12) Patent Application Publication
(10) Pub. No.: US 2011/0045309 A1
(43) Pub. Date: Feb. 24, 2011

(54) METHOD FOR ADJUSTING THE FRICTION COEFFICIENT OF A METALLIC WORKPIECE

(75) Inventors: Gerhard Reusmann, Essen (DE); Thomas Kruse, Dortmund (DE); Heike Mertens, Hagen (DE)

Correspondence Address: BACHMAN & LAPOINTE, P.C., 900 CHAPEL STREET, SUITE 1201, NEW HAVEN, CT, 06510, US

(73) Assignee: EWALD DOERKEN AG, Herdecke (DE)

(21) Appl. No.: 12/922,346

(22) PCT Filed: Mar. 10, 2009
(86) PCT No.: PCT/EP09/01704

§ 371 Date: Nov. 2, 2010

(30) Foreign Application Priority Data
Mar. 13, 2008 (DE) 10 2008 014 027.9

(51) Int. Cl. B32B 15/04; B05D 3/00; B05D 3/10

(52) U.S. Cl. 428/457; 427/331; 427/301

(57) ABSTRACT

The invention relates to a method for adjusting the friction coefficient of the surface of a metallic workpiece by applying and hardening a single-layer or multi-layer coating having a boundary surface facing toward the workpiece and having a boundary surface facing away from the workpiece, wherein one or more base coats each having at least one binding agent and metallic particles, is/are applied in layers, and at least one of the base coats has at least one lubricant. For proposing a possibility for the efficient use of lubricant in anti-corrosion coatings, it is provided that the friction coefficient is adjusted by a lubricant concentration and/or a lubricant composition on the boundary surface facing toward the workpiece that is different from that on the boundary surface facing away from the workpiece

The invention relates to a method for adjusting the friction coefficient of a metallic workpiece.

A corrosion resistant coating is indispensable to increase the service life of metallic workpieces that are exposed to moisture. For galvanized workpieces or workpieces which have been covered with a metal layer by electroplating, US 2007/0196632 A1 discloses a multi-layered coating which shows a high content of lubricants close to the surface of the workpiece, while coating layers which are farther removed from the surface of the workpiece show a reduced content of lubricants. It is assumed that the coating layers applied upon galvanized surfaces or electrolytically deposited metal layers are not wear resistant, so that lubricants in outer coating layers cannot be used expediently. In addition to coating with a continuous metal layer of a suitable metal (e.g., zinc), typically by means of galvanizing, a variant of corrosion protection is coating with an anti-corrosive agent that is applied in liquid form on the workpiece. Such an anti-corrosive agent typically contains metal particles along with a binding agent and a solvent. After applying the anti-corrosive agent on the workpiece, the binding agent hardens under heat, and the metal particles stored within form a more or less continuous protective layer above the metal substrate.

Within the scope of the present invention, an anti-corrosive agent, which as described, comprises a binding agent and metal particles, is designated as a base coat. This designation is used here for both the liquid anti-corrosive agent and for a coating that arises by means of application and hardening, as needed, of at least one such anti-corrosive agent.

Relevant for base coats are particles of metal that offer, on the one hand, anodic corrosion protection because in the case of oxidation they become covered with a weather-resistant protective layer, and on the other hand, offer to exposed parts of the metal substrate also cathodic corrosion protection because they are more base than the substrate and therefore act as a sacrificial anode for this. For both types of protection, it is desirable to have as complete a covering of the substrate as possible by the metal particles, for cathodic corrosion protection it is also necessary for the metal particles to contact one another and the substrate, because only metal particles that are in electrical contact with the substrate can act as sacrificial anodes.

The binding agent can serve also for corrosion protection, however, in contrast to the active corrosion protection due to the metal particles, this is a passive type of protection, i.e., due to a diffusion-inhibiting layer, corrosive influences are kept away from the metal substrate as much as possible.

If specific surface properties are desired beyond the corrosion protection, a top coat to be applied on the base coat is often used for this purpose. The top coat often does not contain any metal particles, and when it does, then only for influencing the appearance and not for active cathodic or anodic corrosion protection. For specific applications, e.g., for threaded parts, lubricants are added to the top coat for adjusting the friction coefficient.

Particularly for small mass-produced-parts that are coated in the dip spin method, two layers of base coat are required as a rule because only in this way are the contact points—that arise depending on the application process—compensated. Therefore, systems used commercially for mass-produced-parts, typically have two corrosion protection base coat layers and one or two top coat layers for adjusting tribological properties.

There is also the option to integrate lubricants in the base coat. With this, there are time and cost savings because it is not necessary to use a separate top coat for adjusting the friction coefficient.

As a result however, there is a disadvantage that for adjusting the desired friction coefficient on the surface a relatively large amount of lubricant must be added to the usually highly pigmented base coat. High costs result from this, in particular, for high quality lubricants such as polytetrafluoroethylene (PTFE).

Therefore, the object of the invention is to propose a possibility for more efficient use of lubricants in anti-corrosion coatings.

The object is solved according to the invention by a method for adjusting the friction coefficient of a metallic workpiece, and by a metallic workpiece as disclosed herein.

With the method according to the invention, a single- or multi-layer coating is applied to the workpiece and hardened, for adjusting the friction coefficient of the surface of a metallic workpiece. For this, one or more base coats, each having at least one binding agent and metallic particles, are applied in layers. At least one of the base coats used has at least one lubricant. If the coating is characterized by a boundary surface facing toward the workpiece and a boundary surface facing away from the workpiece, then, according to the invention the friction coefficient is adjusted by a lubricant concentration that is lower at the boundary surface facing toward the workpiece than at the boundary surface facing away from the workpiece.

The invention is based on the realization that with the targeted selective use of lubricants within a coating built of one or more base coats, it is possible to adjust the desired tribological properties of a workpiece.

Within the method according to the invention, one or more base coats can be applied in layers, which comprise lubricant in different concentrations and/or compositions, which also includes the possibility that at least one base coat (however, not all) does not comprise any lubricant.

It is known to a person skilled in that art that specific lubricants, for example, fatty acids, such as oleic acid or stearic acid, are often introduced as an impurity during the production of raw materials, particularly of metal particles for anti-corrosive agents, without their intended use as a lubricant. These substances are used as a rule as auxiliary substances during the production of metal particles and adhere unavoidably—at least in trace form—to the particles. Smaller quantities of viscous waxes, e.g., polyethylene waxes can be added as an additive, in order to adjust, for example, the rheology of the coating agent. In the scope of this invention, such traces of lubricant are disregarded in the sense that a layer that contains less than 1.0% by weight of lubricant is designated as a layer without lubricant. Only when the percentage by weight is at the named value, or exceeds it, is the layer considered to contain a lubricant.

The method according to the invention allows a very efficient use of lubricants, particularly of solid lubricants. It is now possible to use lubricants in high concentration in the proximity of the boundary surface facing away from the workpiece, where these serve for adjusting a friction coefficient, while less or no lubricant is used in the areas lying beneath. Therefore, the use of lubricants can be limited to the areas where they develop the greatest effect. These are, as a rule, the outer areas of the base coat facing away from the workpiece. During the use of the workpiece, the outer surface of the base coat, i.e., the boundary surface (or at least a part thereof) facing away from the workpiece, is typically the contact surface to another workpiece, thus, for example, the contact point between a screw and a nut. It has been shown that the friction coefficient is specified primarily by the lubricant concentration in the area of this boundary surface. Thus, according to the invention, significantly less lubricant can be used than with the method according to the state of the art. Thereby, considering the very large number of parts to be coated, particularly for mass-produced-parts, decisive cost savings result.

Furthermore, it has been shown that lubricants often dramatically impair the anti-corrosive properties. Lubricant additives, for instance waxes on one hand can interfere with the formation of a continuous film of binding agent and on the other hand become deposited between or on the metal pigment and thus impede the formation of a continuous protective layer. Thus, zinc flake coatings with integrated lubricant, for example, for adjusting the friction coefficient often have less corrosion protection than the analogous coatings without lubricant additive.

Because it is possible with the method according to invention to keep the concentration of lubricant within a base coat selectively low, in particular at the boundary surface facing toward the workpiece, or to use no lubricant there at all, a continuous film of active metal particles can form there. The metal particles used there contribute completely to the active corrosion protection, because without the disruptive influence of the lubricant the necessary contact between the metal particles, typically zinc and/or aluminum particles is guaranteed. The layers of the base coat in which lubricant is used, particularly in higher concentrations, also contribute to the active corrosion protection due to the metal particles contained therein. This is a decisive advantage compared to the method according to the state of the art, in which the lubricant is contained exclusively in the topcoat that does not contain any metal particles for corrosion protection. By means of the method according to the invention a stable, effective anti-corrosive coating arises with a defined adjustable friction coefficient that is superior to previously known coatings.

According to the method according to the invention, for constant lubricant compositions, the lubricant concentration is varied such that the concentration is greater on the boundary surface facing away from the workpiece then on the boundary surface facing toward the workpiece. As already described, it is conceivable here, for example, that little or no lubricant is located in the area of the latter named boundary surface, whereby an optimal corrosion protection can be guaranteed due to the metal particles contained therein. At the same time, in the outer area of the base coat, that is, in proximity to the boundary surface facing away from the workpiece, more lubricant can be present in order to guarantee a defined friction coefficient.

In a further preferred variant of the method, the application of the coating occurs using different lubricants such that in the case of constant lubricant concentration, the lubricant composition on the boundary surface facing toward the workpiece is different from the lubricant composition on the boundary surface facing away from the workpiece. Therefore, for instance, a base coat with a high quality lubricant (e.g., PTFE) can be applied over a base coat with an inexpensive lubricant (e.g., polyethylene).

In this way, costs can be saved compared to the exclusive use of a high quality lubricant in the entire coating. The supplementary use of inexpensive lubricant offers the advantage in the case of damage to the upper layer that the tribological properties of the workpiece remain, due to the lubricant contained in the layer underneath, to a degree that is sufficient for many applications.

In a preferred further development of the method, the lubricant composition has lubricants with a melting point of less than 170° C., preferably less than 150° C. (called low melting point lubricant in the following), and lubricants with a melting point of 150° C. (called high melting point lubricant in the following), preferably of 170° C. or higher, wherein the concentration of lubricants with a melting point of 150° C. or 170° C., or higher, at the boundary surface facing away from the workpiece is different from the concentration at the boundary surface facing toward the workpiece. Examples for the low melting point lubricants are polypropylene (PP) and polyethylene (PE), and examples for the high melting point lubricants are PTFE, molybdenum sulfide, graphite and boron nitride. Therefore, if the binding agent hardens at a temperature of roughly 150° C. or 170° C., or higher, in the course of this thermal hardening process the low melting point lubricants are melted and can possibly crosslink with the binding agent.

Specific high melting temperature lubricants, e.g., PTFE or modified PTFE, ECTFE, or polyvinylidene fluoride (PVDF), which as a rule are contained as particulate in the base coat, under the increased temperatures in the course of the hardening process show a type of “floating”, i.e. they move outward in the direction of the boundary surface facing away from the workpiece. This effect is used in the scope of the method according to the invention, for the purpose of adjusting a higher concentration of these lubricants in the area of the named boundary surface.

The variation possibilities of the method according to the invention are manifold. A combined variation of lubricant concentration and lubricant composition is also conceivable such that the former as well as the latter on the boundary surface facing away from the workpiece are different from those on the boundary surface facing toward the workpiece. Thus, a base coat according to the invention can contain in the proximity to the workpiece, for example, 20% by weight PE, whereas it contains 10% by weight PVCF on the boundary surface facing away from the workpiece. It can be guaranteed with such a combination that in the case of surface damage of the base coat, a substantially unchanged friction coefficient is maintained.

As lubricants, all known substances from the state of the art can be considered, thus, e.g., halogenated hydrocarbons, particularly polytetrafluoroethylene (PTFE), polyvinylidene fluoride (PVDF), tetrafluoroethylene/hexafluoropropylene-copolymer (FEP), perfluoroalkoxy-copolymer (PFA), copolymer of tetrafluoroethylene with perfluorinated propylene and perfluoroalkylvinylether (EPE), copolymer of tetrafluoroethylene and perfluoromethylvinylether (MFA), MoS₂, boron nitride, graphite, fluorinated graphite, carnauba wax, polysulfone, polyolefin resins, particularly polyethylene (PE) and polypropylene (PP), mixtures of the same, or a combination thereof. Here, as already described, it is also possible to use different lubricants by layers.

The metal particles used can be of various types. These can be composed of zinc, aluminum, tin, magnesium, nickel, cobalt, manganese, titanium or alloys thereof. It is also conceivable to mix particles of different metals or alloys. The particles can be present in the shape of flakes, granules, powder or a combination thereof. Zinc flakes or zinc alloy flakes represent a particularly preferred type of metal particles.

With the method according to the invention, base coats with different binding agents can be used that are already known from the state of the art. Silanes, particularly organofunctional silanes, e.g., γ-glycidoxypropyltrimethoxysilane, are an important group of binding agents. Along with silanes, siloxanes, for instance, methyloxypolysiloxane or silicates, for instance, alkali silicates or alkyl silicates are also suitable. In particular, the named binding agents can be used in combination with amine-based curing agents (if necessary, aminosilanes).

Furthermore, binding agents based on titanates can be considered. These typically contain alkyl titanate ester, thus, e.g., monomer esters such as tetrabutyl titanate, but also polymers such as polybutyl titanate.

Chromium VI compounds that can be added, e.g., in the form of salts such as ammonium- or alkali metal chromates, can also serve as binding agents.

The named binding agents polymerize during the hardening process with elimination of water and/or alcohols. Therefore, polymerized products of these binding agents are predominantly found in the hardened coating. Mixtures of the named binding agents, therefore, e.g., of silanes and titanates, which in this case can form a common polymer, are also suitable.

Furthermore, with the method according to the invention organic binding agents such as epoxides, urethanes, acrylates, (e.g., methyl methacrylate) and/or polyester can be used as organic copolymers in connection with the above named inorganic binding agents.

One possible procedure for the adjustment of a friction coefficient according to the invention consists in that initially a first base coat comprising a binding agent, metal particles and optionally a lubricant is applied in the aqueous or organic phase, in a single-layer or multiple layers on the workpiece. Subsequently, at least one further base coat is applied in layers in the aqueous or organic phase, each comprising a binding agent, metal particles and optionally a lubricant. Here, including the first base coat, at least two base coats having different lubricant concentrations and/or lubricant compositions are used. After each of the coating steps, a thermal hardening of the applied coating can occur; alternatively, the layers in their entirety are hardened in a single step of the method.

Here, the procedure can be as follows, for example: Three base coats are applied one after the other, where each contains metal particles for guaranteeing a sufficient corrosion protection, in addition to a binding agent. A first base coat is applied that does not contain any lubricant. Following on top of this, a further base coat is applied that comprises molybdenum sulfide as a lubricant. Finally, a third base coat containing PTFE as a lubricant is applied, after which, thermal hardening of the three-layer coating occurs.

Along with the named components, as is known from the state of the art, further additives can be added to the individual base coats, for instance, thickening agent, defoaming agent, wetting agent, surfactants, fillers or color pigments.

As is known from the state of the art, it is preferred with the method according to the invention that the workpiece is pretreated before the application of the coating. Possible treatment methods here are cleaning, degreasing, etching, sand blasting, compressed air blasting and/or phosphating.

It is proposed in a further development of the invention that a classical single-layer or multi-layer top coat is applied onto the single- or multi-layer coating. In this context, each coating that comprises a binding agent but does not contain any metal pigments for active corrosion protection is designated as a top coat, i.e., there is no differentiation between “top coat” and “sealing”. The top coat, as is known from the state of the art, can optionally contain a lubricant. The possibility exists that the top coat along with color pigments and other components, which are known to the person skilled in the art, contains certain quantity of metal particles for creating a “metallic look”.

In the following the functionality of the invention is explained using example embodiments.

### EXAMPLE 1

For coating steel screws, three baths are prepared with base coats A, B and C. Each of the baths is produced as follows:

29.2% by weight deionized water is mixed while stirring moderately with 4.6% by weight γ-glycidoxypropyltrimethoxysilane and 0.9% by weight boric acid. After 3 hours of stirring, a further 45.1% by weight deionized water and a wetting agent mixture containing 2.3% by weight of a nonionic ethoxylated nonylphenol-wetting agent (“NENN”) with a molar mass of 395 and a specific weight of 1.0298 at 20/20° C. and 2.3% by weight of a NENN with a molar mass of 616 and a specific weight of 1.057 at 20/20° C., are added to the mixture. Then to this mixture, a further 3.1% by weight of the named silane, 6.3% by weight acetone and 1.1% by weight 1-nitropropane are added. To this, zinc paste and powdered PTFE are each added in different percentages by weight depending on the bath. The zinc, in flake form, has a particle thickness of approximately 0.1 to 0.5 μm and a longest dimension of the individual particles of approximately 80 μm. Subsequently, the substances used are mixed for approximately 3 hours in a Cowles dissolver that is operated at approximately 960 rpm. To the resulting mixture then, while the stirring is continued 1 hour, 0.6% by weight sodium bis(tridecyl) sulfosuccinate (anionic wetting agent) is added and the mixing is continued for approximately 12 hours. After the coating agent thusly obtained is aged 6 days, a further 4.5% by weight γ-glycidoxypropyltrimethoxysilane is added while stirring.

The percentages by weight of zinc paste and PTFE are selected so that (relative to 100% by weight of the finished base coat) they are contained in the baths as follows:
Bath A 35% by weight zinc paste and no PTFE,
Bath B 35% by weight zinc paste and 1% by weight PTFE and
Bath C 35% by weight zinc paste and 3% by weight PTFE.

The steel screws are degreased at 75° C. in a cleaning solution composed of water, in which 9 g of potassium phosphate and 27 g potassium hydroxide were dissolved in 1 liter water, and then cleaned with tap water. The degreasing and cleaning procedure is repeated again, and then the screws are dried.

For coating, the screws are placed in a wire basket that is dipped into a bath A. Then, the basket is lifted out of the bath, and the excess base coat is centrifuged off at 300 rpm in two centrifuge procedures, each lasting 10 seconds.

Afterwards, the screws are removed from the basket and the binding agent is pre-dried in the oven for 10 minutes at 70° C., and subsequently hardened at 320° C. for 30 minutes.

After the hardening of the first layer, the screws, in a second wire basket, are dipped into a bath B. Subsequently, the already described centrifuge and hardening procedures are repeated.

Finally, the described coating, centrifuge and hardening procedures are repeated with the base coat in bath C.

The result is an exceedingly thin coating with a thickness of approximately 30 μm, which on the one hand has excellent corrosion protection properties and which on the other hand allows an exact adjustment of the friction coefficient.

### EXAMPLE 2

### Not According to the Invention

For coating steel screws, three baths are prepared with base coats D, E and F. For each of the base coats, a binding agent is produced having the following components:
Trimethoxyvinylsilane: 9.8% by weight, Titan-ethylhexanolate(Tetra-2-ethylhexyl titanate): 24.9% by weight,
N-butyl polytitanate (Titanium tetrabutanolate, polymer): 36.8% by weight,
Alcohol: 14.5% by weight, and
Anti-settling agent: totally 11.4% by weight.
Different anti-settling agents are used, here:
2.6% by weight amorphous silica, 3.1% by weight paint additive Y 25 SN (Ashland) and 5.7% by weight Ethocell 45 solution 11% in alcohol from Ewald Dörken AG, and wetting agent and dispersant: 2.6% by weight Disperbyk 160 solution 20% in aromatic hydrocarbons (Dörken)
Sum: 100% by weight relative to the binding agent

For adjusting the corrosion protection properties, a mixture of zinc paste (zinc paste: 90% by weight zinc powder mixed into a paste with 10% by weight organic solvent) with an average diameter of zinc particles of approximately 4 μm, and aluminum paste is used. Here the weight ratio of zinc paste:aluminum paste amounts to 55:2. Along with the metal particle paste, a lubricant is optionally added to the binding agent, wherein the percentage by weight varies depending on the base coat, as described below.

Each of the base coats is produced in a heatable and coolable mixing vessel with an integrated continuously variable agitator. The components named above for the binding agent, and metal paste and lubricant are mixed together in the preparation container, in the specified sequence, one after the other while stirring. The temperature is between +5° C. and +60° C. The agitator is set to 1,000 rpm, and the content is mixed for 5 minutes after the addition of each component.

The percentage by weight of metal paste and lubricant are selected such that each bath contains:
Bath D 57% by weight paste and no lubricant,
Bath E 57% by weight paste and 5% by weight polyethylene and
Bath F 57% by weight paste and 2% by weight PTFE, each relative to 100% by weight base coat.

Analogous to Example 1, steel screws are coated consecutively in the three baths. Here, the hardening of each of the individual layers occurs within 30 minutes at an object temperature of 200° C.

The result is a coating with excellent corrosion protection properties, where the friction coefficient is exactly adjusted due to the outer layer having PTFE. Due to the presence of the middle layer having polyethylene, sufficiently defined tribological properties are guaranteed, even in the case of damage to the outer layer.

1-14. (canceled)

15. A method for adjusting the friction coefficient of the surface of a metallic workpiece by applying and hardening a single-layer or multi-layer coating having a boundary surface facing toward the workpiece and having a boundary surface facing away from the workpiece, wherein one or more base coats each having at least one binding agent and metallic particles, are applied in layers, and at least one of the base coats has at least one lubricant, wherein the friction coefficient is adjusted by a lubricant concentration that is lower at the boundary surface facing toward the workpiece than at the boundary surface facing away from the workpiece.

16. The method according to claim 15, wherein with a constant lubricant composition, the lubricant concentration at the boundary surface facing away from the workpiece is greater than that at the boundary surface facing toward the workpiece.

17. The method according to claim 15, wherein the lubricant composition at the boundary surface facing toward the workpiece is different from the lubricant composition at the boundary surface facing away from the workpiece.

18. The method according to claim 15 wherein the lubricant composition has lubricants with a melting point of less than 150° C. and lubricants with a melting point of 150° C. or higher, wherein the concentration of lubricants with a melting point of 150° C. or higher at the boundary surface facing away from the workpiece is different from that at the boundary surface facing toward the workpiece.

19. The method according to claim 18, wherein the concentration of lubricants with a melting point of 150° C. or higher at the boundary surface facing away from the workpiece is higher than that at the boundary surface facing toward the workpiece.

20. The method according to claim 18, wherein the concentration of lubricants with a melting point up to 150° C. at the boundary surface facing away from the workpiece is higher than that at the boundary surface facing toward the workpiece.

21. The method according to claim 15, wherein at least one lubricant is selected from the group consisting of halogenated hydrocarbons, MoS₂, boron nitride, graphite, fluorinated graphite, carnauba wax, polysulfone, polyolefin resins, and combinations thereof.

22. The method according to claim 21, wherein the halogenated hydrocarbons are selected from the group consisting of polytetrafluoroethylene (PTFE), polyvinylidene fluoride (PVDF), tetrafluoroethylene/hexafluoropropylene-copolymer (FEP), perfluoroalkoxy-copolymer (PFA), copolymer of tetrafluoroethylene with perfluorinated propylene and perfluoroalkylvinylether (EPE), copolymer of tetrafluoroethylene and perfluoromethylvinylether (MFA), and combinations thereof.

23. The method according to claim 21, wherein the polyolefin resins are selected from the group consisting of polyethylene (PE), polypropylene (PP), and combinations thereof.

24. The method according to claim 15 wherein the metallic particles are selected from the group consisting of zinc, aluminum, tin, magnesium, nickel, cobalt, manganese, titanium and mixture and alloys thereof, in the form of flakes, granules or powder, or in a combination thereof.

25. The method according to claim 15 wherein the binding agent is selected from the group consisting of silanes, siloxanes, silicates, titanates, and chromium IV compounds, mixture or polymerized products thereof or organic copolymers thereof with epoxides, urethanes, acrylates or polyesters or a combination thereof.

26. The method according to claim 15, wherein the applying step comprises the following steps:
applying a single-layer or multiple-layers of a first base coat, comprising a binding agent, metal particles and optionally a lubricant, in aqueous or organic phase onto the workpiece,
subsequently, applying in layers, at least one further base coat, each comprising a binding agent, metal particles and optionally a lubricant in aqueous or organic phase,
wherein at least two base coats with different lubricant concentrations and/or lubricant compositions are used.

27. The method according to claim 15, wherein the workpiece is pretreated before application of the coating by being cleaned, degreased, sand blasted, air blasted, phosphated, primed, or provided with a bonding agent.

28. The method according to claim 15, wherein after the application of the coating, a single-layer or multi-layer top coat is applied.

29. A workpiece with a metallic surface, having a single-layer or multi-layer coating composed of one or more base coats, wherein the coating has a lower lubricant concentration at the boundary surface facing toward the workpiece in comparison to that at the boundary surface facing away from the workpiece.
